(19) United States
(12) Patent Application Publication
(10) Pub. No.: US 2010/0262329 A1
(43) Pub. Date: Oct. 14, 2010

(54) SYSTEM AND METHOD FOR CONTROLLING THE RELEASE OF AN AUTOMATIC PARKING BRAKE DEVICE ONBOARD AN AUTOMOBILE

(75) Inventors: Alessandro Monti, La Garenne-Colombes (FR); Richard Pothin, Jouars-Pontchartrain (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S. A. S., Boulogne-Billancourt (FR)

(21) Appl. No.: 12/675,793

(22) PCT Filed: Jun. 30, 2008
(86) PCT No.: PCT/FR08/51203

§ 371 Date: Jun. 29, 2010

(30) Foreign Application Priority Data
Aug. 31, 2007 (FR) 0757286

(51) Int. Cl. B60T 17/00; G06F 7/00

(52) U.S. Cl. 701/29

(57) ABSTRACT

A system controlling release of an automatic parking brake onboard an automobile, that includes a mechanism estimating torque transmitted by the clutch, a sensor measuring an inclination angle of the rolling surface, and a mechanism controlling release of the parking brake device that compares the torque transmitted by the clutch with a continuous threshold torque depending on the inclination angle of the rolling surface at an end of a vehicle stop.

The present invention relates to a system and a method for controlling the release of an automatic parking brake device, onboard an automobile.

In the state of the art, there is known a manual braking device, called “handbrake”, which is used to mechanically ensure, without the external input of energy, that the vehicle will be maintained in the rest state, even if it is subjected to moderate actions intended to start it moving. Then, because of particular features of the clutch device and the ergonomics of the driving controls, the manual braking device makes it possible to hold a vehicle on a hill when changing gearbox ratio without the vehicle dropping back, since, more often than not, a change of gearbox ratio is preceded by a declutching of the motive power which is disconnected from the wheels, leaving the vehicle subject to the action of gravity and of inertia on the ramp.

In such a so-called “hill start” maneuver or in similar driving situations, the driver must manage the handbrake while changing the ratio on the gearbox, and balance the resumption of forward movement of the vehicle against the effect of gravity in the climb.

The use of an electric brake device when parking makes it possible to automate this task which is then placed under the control of an automatic control function.

Thus, automatic parking brake devices have been developed to replace manual parking brakes. They are connected to a computer which makes it possible, according to various signals representative of engine operating parameters, to release the brakes without the direct intervention of the driver of the vehicle.

The French patent application No. 2 828 450 (RENAULT) discloses a system for controlling the release of an automatic parking brake device, onboard an automobile, wherein, when conditions representative of a hill start or maneuver are produced, a parking brake release command is emitted a plurality of times, addressed to brake actuators. In the event of failure of the sensor detecting the neutral position of the gearshift lever or the reverse position sensor of the gearshift lever, such a system can control the release of the parking brake device as a result of false information transmitted by at least one of these two sensors when the parking brake device must not be released.

Similarly, the French patent application No. 2 841 199 (RENAULT) controls the release of the parking brake device according to a comparison between a transmitted torque estimation and a transmitted torque estimation threshold value. However, such a system can pose operating problems in the event of the failure or an operating fault of at least one of the neutral position and reverse position sensors of the gearshift lever, used in computing the transmitted torque estimation threshold value.

One aim of the invention is to provide a system and a method for controlling the release of an automatic parking brake device which avoids any refusal to release the parking brake following failure of or an operating fault of the neutral position sensor and/or the reverse position sensor of the gearbox.

There is proposed, according to one aspect of the invention, a system for controlling the release of an automatic parking brake device, onboard an automobile, and comprising means of estimating the torque transmitted by the clutch, a sensor for measuring the tilt angle of the rolling surface, and means of controlling the release of the parking brake device that are provided with first means of comparing the torque transmitted by the clutch with a continuous threshold torque dependent on the tilt angle of the rolling surface at the end of a stoppage of the vehicle. The threshold torque is an even function of the tilt angle of the rolling surface at the end of a stoppage of the vehicle, and comprises a first portion that decreases for values of the tilt angle of the rolling surface at the end of a stoppage of the vehicle that are below a first negative threshold, a second portion that is constant and positive for values of the tilt angle of the rolling surface at the end of a stoppage of the vehicle that are contained between the first negative threshold and a second positive threshold, and a third portion that increases for values of the tilt angle of the rolling surface at the end of a stoppage of the vehicle that are above the second positive threshold.

Thus, when an operating fault or a failure of the neutral point position sensor or of the gearbox reverse position sensor is detected, the release of the parking brake when a movement is initiated on an inclined rolling surface will avoid damaging the brakes, the brake calipers and the tires by having identical release conditions when a movement of the vehicle is initiated in the downhill or uphill direction.

In one embodiment, the means of estimating the torque transmitted by the clutch comprise first means of subtracting a first torque value corresponding to the maximum error, as an absolute value, in estimating the torque transmitted by the clutch.

The accuracy of the operation of the system is thus improved, and the driver is certain to be able to start the vehicle moving when the transmitted torque is sufficient.

In one embodiment, the means of estimating the torque transmitted by the clutch comprise means of computing a second torque value transmitted to elements connected to the engine, and second means of subtracting said second torque value, when estimating the torque transmitted by the clutch.

The accuracy of the operation of the device is improved, by avoiding counting, in the torque available for the start, a torque used or absorbed by ancillary elements connected to the engine.

In one embodiment, the system comprises a pedal for controlling the power of the engine and a sensor sensing the position of the power control pedal. The means of controlling the release of the parking brake device are, furthermore, provided with second means of comparing the position of the pedal for controlling the power of the engine with a threshold position.

For example, the means of controlling the release of the parking brake device comprise a map of the threshold position of the power control pedal, according to the engine rotation speed and the absolute value of the tilt angle of the rolling surface at the end of a stoppage of the vehicle.

A stoppage of the vehicle corresponds to a phase during which its speed is substantially zero or less than a minimum speed.

In one embodiment, the means of controlling the release of the parking brake device are, furthermore, provided with third means of comparing the engine for controlling the power of the engine with a threshold rotation speed.

In one embodiment, the means of controlling the release of the parking brake device are adapted to release the parking brake device when the vehicle is stopped, when the driver orders the vehicle to move, and when the torque transmitted by the clutch is above the threshold torque, the position of the pedal for controlling the power of the engine is above the threshold position, and the engine is above the threshold rotation speed.

In one embodiment, the system further comprises a clutch control pedal, a sensor sensing the position of the clutch control pedal, and fourth means for comparing another estimation of the torque transmitted by the clutch with said threshold torque. The other estimation of the torque transmitted by the clutch is delivered by a map according to the position of the clutch control pedal.

Thus, in the particular case in which the vehicle is equipped with a manual gearbox, it is possible to improve the operating accuracy of the device by means of another estimation of the torque transmitted by the clutch, by a map, and comparison with said threshold torque.

Indeed, the above applies to manual, automatic or robotized gearboxes.

In one embodiment, the means of controlling the release of the parking brake device are adapted to release the parking brake device when the vehicle is stopped, when the driver orders a hill start or maneuver, and when the torque transmitted by the clutch is above the threshold torque, the position of the pedal for controlling the power of the engine is above the threshold position, the engine rotation speed is above the threshold rotation speed, and the other estimation of the torque transmitted by the clutch is above the threshold torque.

The accuracy of this system is improved for this embodiment comprising an automatic gearbox.

According to another aspect of the invention, there is also proposed a method of controlling the release of an automatic parking brake device onboard an automobile, wherein the torque transmitted by the clutch is compared with a continuous threshold torque dependent on the tilt angle of the rolling surface at the end of a stoppage of the vehicle. The threshold torque is an even function of the tilt angle of the rolling surface at the end of a stoppage of the vehicle, and comprises a first portion that decreases for values of the tilt angle of the rolling surface at the end of a stoppage of the vehicle that are below a first negative threshold, a second portion that is constant and positive for values of the tilt angle of the rolling surface at the end of a stoppage of the vehicle that are contained between the first negative threshold and a second positive threshold, and a third portion that increases for values of the tilt angle of the rolling surface at the end of a stoppage of a vehicle that are above the second positive threshold.

Other benefits and features of the invention will become apparent from examining the detailed description of an implementation and an embodiment that are by no means limiting, and the appended drawings, in which:

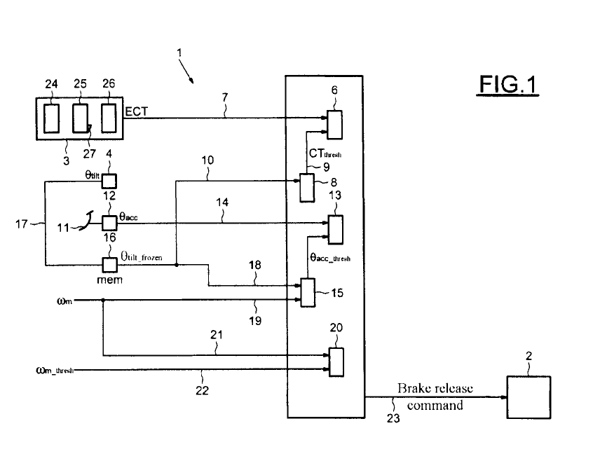

FIG. 1 is a block diagram of a system for controlling the release of an automatic parking brake device according to one aspect of the invention;

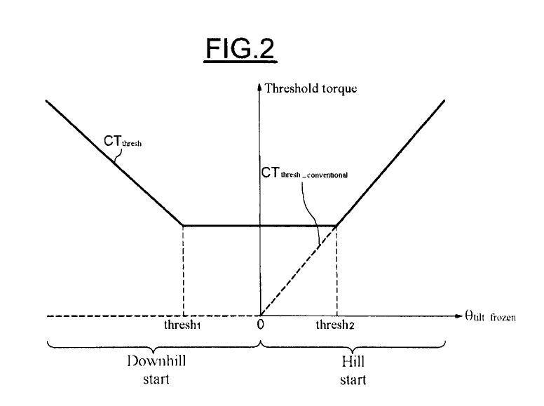

FIG. 2 diagrammatically illustrates the threshold torque with which the torque transmitted by the clutch is compared;

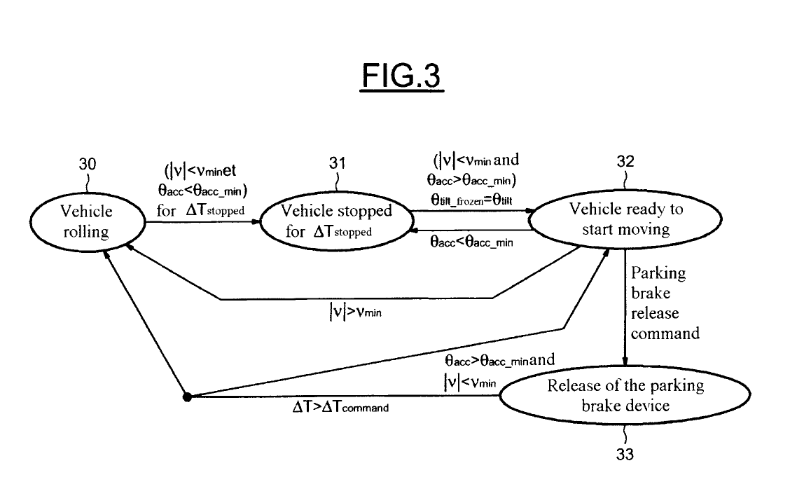

FIG. 3 is a state diagram illustrating the detection of a request to start the vehicle on an inclined rolling surface after a stopping period during which the automatic parking brake device of the vehicle has been activated, for a system according to FIG. 1;

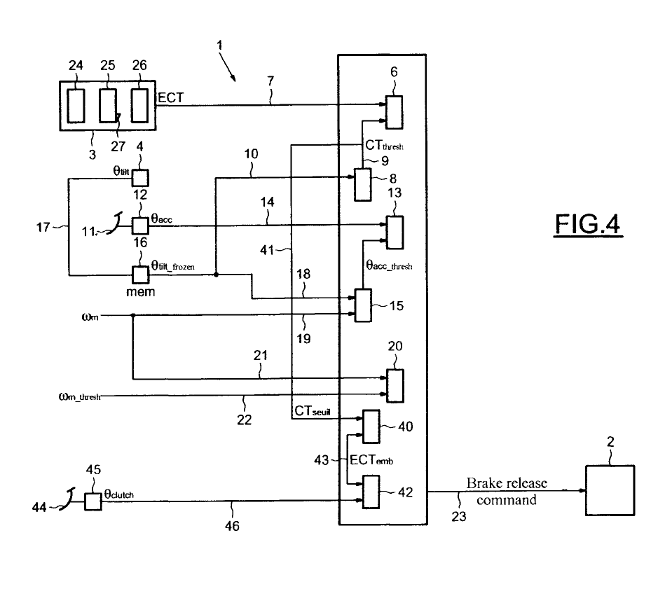

FIG. 4 diagrammatically illustrates a system for controlling the release of an automatic parking brake device, wherein the vehicle is equipped with a manual gearbox; and

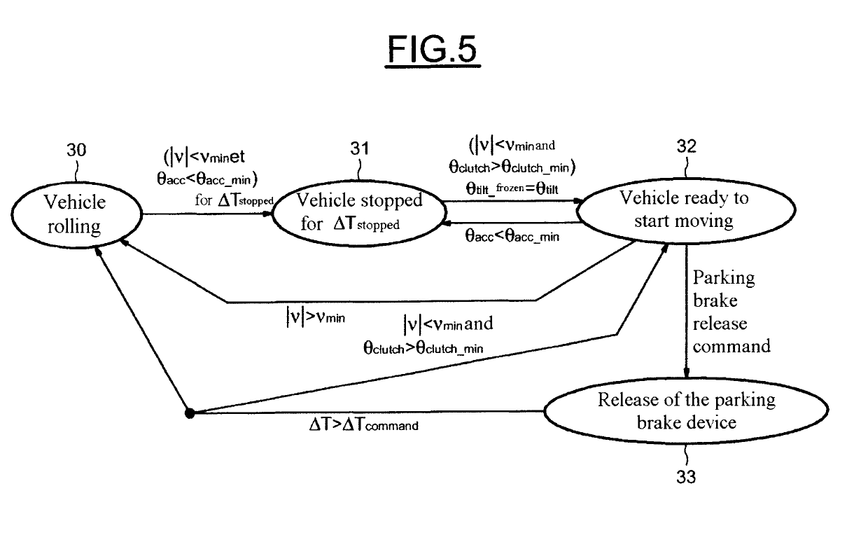

FIG. 5 is a state diagram illustrating the detection of a request to start the vehicle on an inclined rolling surface after a stopping period during which the automatic parking brake device of the vehicle has been activated, for a system according to FIG. 4.

FIG. 1 illustrates an exemplary system 1 for controlling the release of an automatic parking brake device 2 onboard an automobile. The vehicle can comprise a manual, automatic or robotized gearbox. The system comprises a module 3 for estimating the torque ECT transmitted by the clutch, a sensor 4 for measuring the tilt angle θₜᵢₗₜ of the rolling surface of the vehicle, and a module 5 for controlling the release of the parking brake device 2.

The control module 5 comprises a first module 6 for comparing the torque ECT transmitted by the clutch with a threshold torque CTₜₕᵣₑₛₕ. The torque ECT transmitted by the clutch is supplied by the estimation module 3 to the first comparison module 6 via a connection 7. A stored map 8 of the control module 5 supplies the first comparison module 6 with a threshold torque CTₜₕᵣₑₛₕ via a connection 9, according to the frozen tilt angle θₜᵢₗₜ_{_{—}}_{frozen} of the rolling surface of the vehicle delivered by a storage module 16, via a connection 10.

The system comprises a pedal 11 for controlling the power of the engine, or accelerator pedal, and an associated position sensor 12 delivering at the output the position θ_{acc} of the power control pedal 11 to a second comparison module 13 via a connection 14. The second comparison module 13 compares the position θ_{acc} of the power control pedal 11 with a threshold position θ_{acc}_{_{—}}ₜₕᵣₑₛₕ supplied by a map 15 according to the engine rotation speed ωₘ, measured by a sensor or estimated by an estimator, and the absolute value |θₜᵢₗₜ_{_{—}}_{frozen}| of the tilt angle θₜᵢₗₜ_{_{—}}_{frozen} of the rolling surface at the end of a stoppage of the vehicle.

The storage module 16 stores the value of the tilt angle θₜᵢₗₜ supplied by the measurement sensor 4 via a connection 17 at the end of a stoppage of the vehicle, or, in other words, at the moment when the system 1 detects conditions involving the vehicle starting to move, after a phase during which the vehicle has had a virtually zero speed. The map 15 of the threshold position θ_{acc}_{_{—}}ₜₕᵣₑₛₕ receives the value of the tilt angle of the rolling surface at the end of a stoppage of the vehicle via a connection 18 tapped from the connection 10, and the engine rotation speed via a connection 19.

The control module 5 also comprises a third module 20 for comparing the engine rotation speed ωₘ, received via a connection 21, with a threshold rotation speed ωₘ_{_{—}}ₜₕᵣₑₛₕ, stored in a memory or estimated by an estimator and received via a connection 22.

The control module 5 is adapted to control, via a connection 23, the release of the parking brake device 2, when the vehicle is stopped, or, in other words, at a speed that is substantially zero or below, as an absolute value, at a minimum speed vₘᵢₙ, when the driver asks for the vehicle to move, and when the torque ECT transmitted by the clutch is above the threshold torque CTₜₕᵣₑₛₕ, the position θ_{acc} of the pedal 11 for controlling the power of the engine is above the threshold position θ_{acc}_{_{—}}ₜₕᵣₑₛₕ and the engine rotation speed ωₘ is above the threshold rotation speed ωₘ_{_{—}}ₜₕᵣₑₛₕ. These comparisons are made by the first, second and third comparison modules 6, 13 and 20.

Optionally, the estimation module 3 can comprise a first subtraction module 24 for subtracting a first torque value corresponding to the maximum of errors as an absolute value, when estimating the torque ECT transmitted by the clutch.

Furthermore, the estimation module 3 can comprise, also optionally, a module 25 for computing a second torque value transmitted to elements connected to the engine of the vehicle, and a second module 26 for subtracting said second torque value, when estimating the torque transmitted by the clutch. The computation module 25 transmits to the second subtraction module 26 the second torque value via a connection 27.

FIG. 2 represents the determination of the threshold torque CTₜₕᵣₑₛₕ according to the frozen tilt angle θₜᵢₗₜ_{_{—}}_{frozen} of the rolling surface. This determination is made by the map 8, or, as a variant, by a computation module using a function representative of the curve of FIG. 2.

The broken line curve represents a threshold torque CTₜₕᵣₑₛₕ_{_{—}}_{conventional} often used in other systems for controlling the release of an automatic parking brake device, for which, when it is not possible to determine whether the movement is being started in the downhill or uphill direction, following a malfunction or a failure of a sensor, the system does not order the release of the parking brake device, and the vehicle cannot be moved as long as this control system is active.

The threshold torque CTₜₕᵣₑₛₕ is a continuous and even function, that is to say for which CTₜₕᵣₑₛₕ(θₜᵢₗₜ_{_{—}}_{frozen})=CTₜₕᵣₑₛₕ(−θₜᵢₗₜ_{_{—}}_{frozen}). The threshold torque CTₜₕᵣₑₛₕ comprises a first portion that decreases for values of the tilt angle of the rolling surface that are below a first negative threshold thresh₁, a second portion that is constant and positive for values of the tilt angle of the rolling surface that are contained between the first negative threshold thresh₁ and a second positive threshold thresh₂, and a third portion that increases for values of the tilt angle of the rolling surface that are above the second positive threshold thresh₂. Since the function is even, the first negative threshold thresh₁ is the opposite of the second positive threshold thresh₂, or, in other words, thresh₁=−thresh₂.

In other words, the threshold torque CTₜₕᵣₑₛₕ can be defined by the following system:

$$\{ \begin{matrix}{r}_{max} \cdot {ρ}_{wheels} \cdot m \cdot g \cdot sin ( {θ}_{tili\_min} ) & if \vert {θ}_{tilt\_frozen} \vert \leq {θ}_{tilt\_min} \\ {r}_{max} \cdot {ρ}_{wheels} \cdot m \cdot g \cdot sin ( \vert {θ}_{tili\_frozen} \vert ) & if \vert {θ}_{tilt\_frozen} \vert > {θ}_{tilt\_min}\end{matrix}$$

in which:
rₘₐₓ is the maximum of the ratio r(1) of the first gear and of the ratio r(−1) of reverse; and
θₜᵢₗₜ_{_{—}}ₘᵢₙ is a predetermined parameter that makes it possible to avoid having a zero threshold torque when the tilt of the rolling surface is low, i.e. contained between the thresholds thresh₁ and thresh₂.

Thus, thanks to the use of such a torque threshold CTₜₕᵣₑₛₕ even in the event of erroneous information on the direction in which the vehicle is being started on an inclined rolling surface, a blockage of the system 1 for controlling the release of the automatic parking brake device 2 onboard the automobile is avoided.

The broken line curve representing a torque threshold CTₜₕᵣₑₛₕ_{_{—}}_{conventional}, often used in other systems for controlling the release of an automatic parking brake device, can be determined by the following equation:

CTₜₕᵣₑₛₕ_{_{—}}_{conventional}=r(b)·ρ_{wheels}m·g·sin(θₜᵢₗₜ)

in which:
r(b) is the gear ratio corresponding to the position b of the gearshift lever. For a start of the vehicle in the direction of the slope, CTₜₕᵣₑₛₕ_{_{—}}_{conventional} is set at 0 Nm;
ρ_{wheels} is the radius of the wheels of the vehicle, in m;
m is the weight of vehicle, in kg,
θₜᵢₗₜ is the tilt of the rolling surface of the vehicle, in rad; and
g is the gravitational field on the surface of the Earth, substantially equal to 9.81 m·s⁻²

This equation illustrates that, for a vehicle immobilized on a slope, when started, the latter can overcome the gravitational force. This force depends on the tilt of the slope θₜᵢₗₜ, and the mass m of the vehicle, and has the value m·g sin(θₜᵢₗₜ).

The torque transmitted by the clutch can, for example, be computed, by the estimation module 3, by means of the following equation:

ECT=C_{M}−J_{M}·\dot{ω}_{M}

in which
C_{M} is the torque supplied by the engine, in Nm;
J_{M} is the inertia of the engine, in kg·m²·rad⁻¹; and
\dot{ω}_{M} is the temporal derivative of the engine rotation speed, in rad·s⁻².

FIG. 3 illustrates the operation of a system according to FIG. 1. The state 30 corresponds to the vehicle rolling at a speed v such that its absolute value is greater than a minimum speed vₘᵢₙ and the driver has reduced his power demand so that the position θ_{acc} of the power control pedal 11 is below a minimum position θ_{acc}_{_{—}}ₘᵢₙ for a duration ΔT_{stopped}. When these conditions are satisfied, the system switches to a state 31, in which the vehicle is considered to be stopped for the duration ΔT_{stopped}.

When the system is in the state 31, when the vehicle is stopped for the duration ΔT_{stopped} if the absolute value of the speed is less than the minimum speed vₘᵢₙ, when the position θ_{acc} of the power control pedal 11 is above the minimum position θ_{acc}_{_{—}}ₘᵢₙ, that is to say that the driver is pressing on the power control pedal 11, then the value of the tilt of the rolling surface θₜᵢₗₜ, delivered by the sensor 4, is stored in the memory 16 as an absolute value, and the threshold torque CTₜₕᵣₑₛₕ is computed. In these conditions, the system switches to the state 32 for which the vehicle is ready to be started.

In the state 32, when the vehicle is ready to be started, if the driver releases his pressure on the power control pedal 11, so that the position θ_{acc} of the power control pedal 11 is below the minimum position θ_{acc}_{_{—}}ₘᵢₙ the system switches back to the state 31, in which the vehicle is considered to be stopped for a duration ΔT_{stopped}. If the speed of the vehicle becomes greater, as an absolute value, than the minimum speed vₘᵢₙ, the system switches back to the state 30, in which the vehicle is considered to be rolling. However, if the test conditions produced by the first, second and third comparators 6, 13 and 20 of the control module 5 correspond to the conditions defined previously for a command to release the parking brake device 2, the system switches to a state 33 for which the parking brake device is released.

After a duration ΔT, greater than a duration ΔT_{command} corresponding to the maximum brake release time, for example one second, if the position θ_{acc} of the power control pedal 11 is above the minimum position θ_{acc}_{_{—}}ₘᵢₙ, and the absolute value of the speed of the vehicle is less than the minimum speed vₘᵢₙ, the system switches back to the state 32, and otherwise switches back to the state 30.

FIG. 4 illustrates another exemplary system 1 for controlling the release of an automatic parking brake device 2 onboard an automobile, for a vehicle equipped with a manual gearbox. The elements that are common with those of the embodiment of FIG. 1 are numbered with the same references.

Furthermore, the system comprises a fourth module 40 for comparing another estimation ECT_{emb} of the torque transmitted by the clutch with the threshold torque CTₜₕᵣₑₛₕ transmitted via a connection 41 tapped from the connection 9. The other estimation ECT_{emb} of the torque transmitted by the clutch is supplied by a map 42, via a connection 43. The map 42 delivers to the output, via a connection 46, the other estimation ECT_{emb} of the torque transmitted by the clutch, based on the position θ_{clutch} of a clutch control pedal 44, measured by a position sensor 45 associated with the clutch control pedal 44.

The operation of the control system is thus improved, because it takes account of two estimations of the torque transmitted by the clutch.

FIG. 5 is a state diagram illustrating the operation of the system of FIG. 4, for a vehicle equipped with a manual gearbox.

The state 30 corresponds to the vehicle rolling at a speed v such that its absolute value is greater than a minimum speed vₘᵢₙ and the driver has reduced his power demand so that the position θ_{clutch} of the clutch control pedal 44 is below a minimum position θ_{clutch}_{_{—}}ₘᵢₙ for a duration ΔT_{stopped}. When these conditions are satisfied, the system switches to a state 31, in which the vehicle is considered to be stopped for the duration ΔT_{stopped}.

When the system is in the state 31, the vehicle is stopped for the duration ΔT_{stopped}, if the absolute value of the speed is less than the minimum speed vₘᵢₙ, the position θ_{clutch} of the clutch control pedal 44 is below the minimum position θ_{clutch}_{_{—}}ₘᵢₙ, that is to say that the driver is pressing on the clutch control pedal 44, then the value of the tilt of the rolling surface θₜᵢₗₜ, delivered by the sensor 4, is stored in the memory 16, and the threshold torque CTₜₕᵣₑₛₕ is computed. In these conditions, the system switches to the state 32 for which the vehicle is ready to be started.

In the state 32, when the vehicle is ready to be started, if the driver releases his pressure on the power control pedal 11, so that the position θ_{acc} of the power control pedal 11 is below the minimum position θ_{acc}_{_{—}}ₘᵢₙ the system switches back to the state 31, in which the vehicle is considered to be stopped for a duration ΔT_{stopped}. If the speed of the vehicle becomes greater, as an absolute value, than the minimum speed vₘᵢₙ, the system switches back to the state 30, in which the vehicle is considered to be rolling. However, if the test conditions produced by the first, second and third comparators 6, 13 and 20 of the control module 5 correspond to the conditions defined previously for a command to release the parking brake device 2, the system switches to a state 33 for which the parking brake device is released.

After a duration ΔT, greater than the duration ΔT_{command}, if the position θ_{clutch} of the clutch control pedal 44 is above the minimum position θ_{clutch}_{_{—}}ₘᵢₙ, and the absolute value of the speed of the vehicle is less than the minimum speed vₘᵢₙ, the system switches back to the state 32, and otherwise switches back to the state 30.

Thus, the invention makes it possible to avoid a vehicle equipped with a system for controlling the release of an automatic parking brake device remaining blocked in the event of failure or malfunction of the sensor detecting the neutral position of the gearshift lever or of the sensor detecting the reverse position of the gearshift lever.

1-10. (canceled)

11. A system controlling release of an automatic parking brake device, onboard an automobile, and comprising:
means for estimating torque transmitted by a clutch;
a sensor measuring a tilt angle of the rolling surface; and
means for controlling release of the parking brake device that includes first means for comparing the torque transmitted by the clutch with a continuous threshold torque dependent on the tilt angle of a rolling surface at an end of a stoppage of the vehicle,
wherein the threshold torque is an even function of the tilt angle of the rolling surface at the end of the stoppage of the vehicle, and comprises a first portion that decreases for values of the tilt angle of the rolling surface at the end of the stoppage of the vehicle that are below a first negative threshold, a second portion that is constant and positive for values of the tilt angle of the rolling surface at the end of the stoppage of the vehicle that are contained between the first negative threshold and a second positive threshold, and a third portion that increases for values of the tilt angle of the rolling surface at the end of the stoppage of the vehicle that are above the second positive threshold.

12. The system as claimed in claim 11, wherein the means for estimating the torque transmitted by the clutch comprises means for subtracting a first torque value corresponding to the maximum error, as an absolute value, in estimating the torque transmitted by the clutch.

13. The system as claimed in claim 11, wherein the means for estimating the torque transmitted by the clutch comprises means for computing a second torque value transmitted to elements connected to the engine, and means for subtracting the second torque value, when estimating the torque transmitted by the clutch.

14. The system as claimed in claim 11, further comprising:
a pedal controlling power of the engine; and
a sensor sensing a position of the power control pedal,
wherein the means for controlling the release of the parking brake device further comprise means for comparing the position of the pedal for controlling the power of the engine with a threshold position.

15. The system as claimed in claim 14, wherein the means for controlling the release of the parking brake device comprises a map of the threshold position of the power control pedal, according to an engine rotation speed and an absolute value of the tilt angle of the rolling surface at the end of the stoppage of the vehicle.

16. The system as claimed in claim 11, wherein the means for controlling the release of the parking brake device further include means for comparing engine rotation speed with a threshold rotation speed.

17. The system as claimed in claim 11, wherein the means for controlling the release of the parking brake device is adapted to release the parking brake device when the vehicle is stopped, when the driver orders the vehicle to move, and when the torque transmitted by the clutch is above the threshold torque, the position of the pedal for controlling the power of the engine is above the threshold position, and the engine is above the threshold rotation speed.

18. The system as claimed in claim 11, further comprising:
a clutch control pedal;
a sensor sensing the position of the clutch control pedal; and
means for comparing another estimation of the torque transmitted by the clutch with the threshold torque, the other estimation of the torque transmitted by the clutch being delivered by a map according to the position of the clutch control pedal.

19. The system as claimed in claim 18, wherein the means for controlling the release of the parking brake device is adapted to release the parking brake device when the vehicle is stopped, when a driver orders a hill start or maneuver, and when the torque transmitted by the clutch is above the threshold torque, the position of the pedal for controlling the power of the engine is above the threshold position, the engine rotation speed is above the threshold rotation speed, and the other estimation of the torque transmitted by the clutch is above the threshold torque.

20. A method of controlling release of an automatic parking brake device onboard an automobile, comprising:
comparing torque transmitted by a clutch with a continuous threshold torque dependent on a tilt angle of a rolling surface at an end of a stoppage of the vehicle,
wherein the threshold torque is an even function of the tilt angle of the rolling surface at the end of the stoppage of the vehicle, and comprises a first portion that decreases for values of the tilt angle of the rolling surface at the end of the stoppage of the vehicle that are below a first negative threshold, a second portion that is constant and positive for values of the tilt angle of the rolling surface at the end of the stoppage of the vehicle that are contained between the first negative threshold and a second positive threshold, and a third portion that increases for values of the tilt angle of the rolling surface at the end of the stoppage of the vehicle that are above the second positive threshold.
